(19) United States
(12) Patent Application Publication
(10) Pub. No.: US 2013/0195626 A1
(43) Pub. Date: Aug. 1, 2013

(54) BEARING

(71) Applicants: Brian Tyler White, Statham, GA (US); David R. Torlai, Torrington, CT (US)

(72) Inventors: Brian Tyler White, Statham, GA (US); David R. Torlai, Torrington, CT (US)

(73) Assignee: Carrier Corporation, Farmington, CT (US)

(21) Appl. No.: 13/878,121

(22) PCT Filed: Sep. 28, 2011
(86) PCT No.: PCT/US11/53584

§ 371 Date: Apr. 5, 2013

Related U.S. Application Data
(60) Provisional application No. 61/390,731, filed on Oct. 7, 2010.

(51) Int. Cl. F16C 19/00; F16C 33/62; F16D 27/04

(52) U.S. Cl. CPC F16C 19/00; F16D 27/04; F16C 33/62
USPC 415/123; 384/492; 384/569; 192/66.3

(57) ABSTRACT

A clutch bearing (34) for a transportation refrigeration unit includes one or more rolling elements (38) supportive of one or more components of an electromagnetic clutch for a transportation refrigeration unit, and a plurality of bearing races (36) configured to retain the one or more rolling elements. The bearing races include a coating of thin dense chromium to reduce corrosion and/or damage of the clutch bearing. A transportation refrigeration unit includes a power source (12) and a blower (32) of the transportation refrigeration unit. An electromagnetic clutch (14) is operably connected to the power source and the blower (132) and includes a rotor (16) positioned at a central axis and an armature (18) positioned at the central axis and having an axial air gap (22) to the rotor when the clutch is in a disengaged position. A clutch bearing is located at the central axis and is supportive of the rotor.

### BACKGROUND OF THE INVENTION

The subject matter disclosed herein relates to bearings. More specifically, the subject disclosure relates to clutch bearings for transport refrigeration systems.

In a transportation refrigeration unit in, for example, a trailer or rail car, a clutch, such as an electromagnetic clutch, serves as the interface between a power supply such as an engine and an evaporator blower of the refrigeration unit. When the clutch is engaged, rotational energy is transferred from the power supply to the blower. When the evaporator unit is not running, and the clutch is disengaged, the bearings are not rotating, but are still subject to vibratory forces. Vibratory forces cause wear such as false brinelling or fretting corrosion in the bearings resulting in damage to and/or failure of the bearings which requires premature replacement of the bearings.

### BRIEF DESCRIPTION OF THE INVENTION

According to one aspect of the invention, a clutch bearing for a transportation refrigeration unit includes one or more rolling elements supportive of one or more components of an electromagnetic clutch for a transportation refrigeration unit, and bearing races configured to retain the one or more rolling elements. The bearing races include a coating of thin dense chromium to reduce corrosion and/or damage of the clutch bearing.

According to another aspect of the invention, an electromagnetic clutch for a transportation refrigeration unit includes a rotor located at a central axis and an armature located at the central axis and having an axial air gap to the rotor when the clutch is in a disengaged position. A clutch bearing is positioned at the central axis and is supportive of the rotor. The clutch bearing includes one or more rolling elements supportive of one or more components of the electromagnetic clutch and bearing races configured to retain the one or more rolling elements. The bearing races include a coating of thin dense chromium to reduce corrosion and/or damage of the clutch bearing.

According to yet another aspect of the invention, a transportation refrigeration unit includes a power source and a blower of the transportation refrigeration unit. An electromagnetic clutch is operably connected to the power source and the blower and is located between the power source and the blower such that engagement of the electromagnetic clutch allows for transfer of rotational energy from the power source to the blower. The electromagnetic clutch includes a rotor positioned at a central axis and an armature positioned at the central axis and having an axial air gap to the rotor when the clutch is in a disengaged position. A clutch bearing is located at the central axis and is supportive of the rotor. The clutch bearing includes one or more rolling elements supportive of one or more components of the rotor and bearing races configured to retain the one or more rolling elements and including a coating of thin dense chromium to reduce corrosion and/or damage of the clutch bearing.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial schematic view of an embodiment of a transportation refrigeration unit; and

FIG. 2 is a cross-sectional view of an embodiment of a clutch bearing for a transportation refrigeration unit.

The detailed description explains embodiments of the invention, together with advantages and features, by way of example with reference to the drawings.

### DETAILED DESCRIPTION OF THE INVENTION

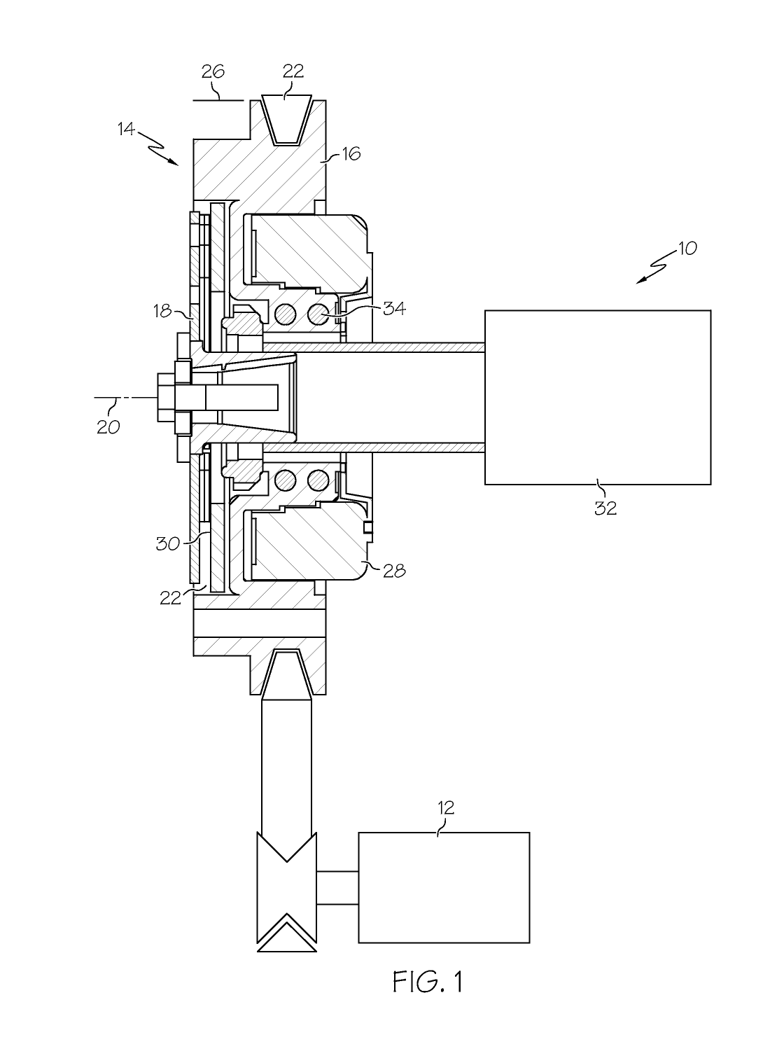

Shown in FIG. 1 is a partial view of an embodiment of a transportation refrigeration unit 10, more particularly an interface between the transport refrigeration unit 10 and a power supply 12, for example an engine of a railway or other vehicle. The interface in FIG. 1 is an electromagnetic clutch 14. The electromagnetic clutch 14 includes a rotor 16 and an armature 18 located about a center axis 20. When the electromagnetic clutch 14 is in a disengaged position, there is an axial gap 22 between the rotor 16 and the armature 18. The rotor 16 is connected to the power supply 12, for example, a vehicle engine. In the embodiment of FIG. 1, the rotor 16 is configured substantially as a pulley, and is driven by a belt 24, located at an outer diameter 26 of the rotor 16, which is connected to the power supply 12. The electromagnetic clutch 14 includes a field coil 28 that, when energized, creates a magnetic field that draws the armature 18 into contact with a face 30 of the rotor 16. The frictional contact caused by the strength of the magnetic field results in a transfer of rotational energy from the rotor 16 to the armature 18. Rotation of the armature 18 drives a blower 32 of the refrigeration unit 10 to which it is connected.

The rotor 16 is supported at an inner diameter by a bearing 34. The bearing 34, as shown in FIG. 1, is a deep-groove ball bearing, but it is to be appreciated that other types of rolling element bearings 34 may be utilized and are contemplated within the scope of the present disclosure. These include angular contact bearings, taper bearings, spherical bearings, cylindrical bearings, needle bearings, or the like.

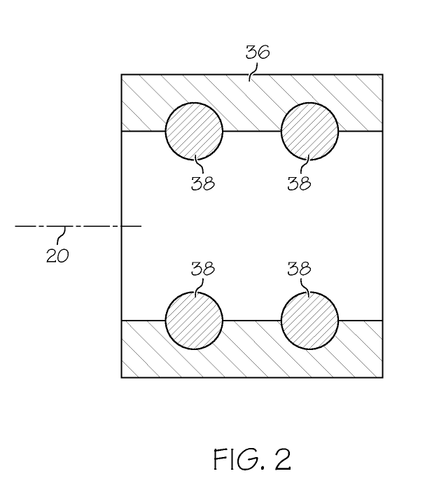

Referring to FIG. 2, a bearing race 36 supports rolling elements 38 of the bearing 34. An inner surface of the bearing race 36, which contacts the rolling elements 38, is coated with a thin dense chromium coating such as available from a variety of sources, for example, Armoloy® of Illinois, Inc. The thin dense chromium coating from Armoloy® is a specific type of thin dense chromium, nodular thin dense chromium. In some embodiments, the coating can be as thin as 0.000040″. The coating prevents false brinelling and/or fretting corrosion which can occur between a steel rolling element 38 and a steel bearing race 36. In some embodiments, to further prevent false brinelling and fretting corrosion, the rolling elements 38 are formed from a ceramic material, thus eliminating some of the steel from the bearing 34.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A clutch bearing for a transportation refrigeration unit comprising:
one or more rolling elements supportive of one or more components of an electromagnetic clutch for a transportation refrigeration unit; and
a plurality of bearing races configured to retain the one or more rolling elements, the plurality of bearing races including a coating of thin dense chromium to reduce corrosion and/or damage of the clutch bearing.

2. The clutch bearing of claim 1, wherein the coating is at least 0.000040″ thick.

3. The clutch bearing of claim 1, wherein the bearing is one of a roller bearing, angular contact bearing, taper bearing, spherical bearing, cylindrical bearing or needle bearing.

4. The clutch bearing of claim 1, wherein the rolling elements are formed from a ceramic material.

5. An electromagnetic clutch for a transportation refrigeration unit comprising:
a rotor disposed at a central axis;
an armature disposed at the central axis and having an axial air gap to the rotor when the clutch is in a disengaged position; and
a clutch bearing disposed at the central axis and supportive of the rotor, the clutch bearing including:
one or more rolling elements supportive of the rotor; and
a plurality of bearing races configured to retain the one or more rolling elements, the bearing race including a coating of thin dense chromium to reduce corrosion and/or damage of the clutch bearing.

6. The electromagnetic clutch of claim 5, wherein the coating is at least 0.000040″ thick.

7. The electromagnetic clutch of claim 5, wherein the bearing is one of a roller bearing, angular contact bearing, taper bearing, spherical bearing, cylindrical bearing or needle bearing.

8. The electromagnetic clutch of claim 5, wherein the rolling elements are formed from a ceramic material.

9. A transportation refrigeration unit comprising:
a power source;
a blower of the transportation refrigeration unit; and
an electromagnetic clutch operably connected to the power source and the blower and disposed between the power source and the blower such that engagement of the electromagnetic clutch allows for transfer of rotational energy from the power source to the blower, the electromagnetic clutch including:
a rotor disposed at a central axis;
an armature disposed at the central axis and having an axial air gap to the rotor when the clutch is in a disengaged position; and
a clutch bearing disposed at the central axis and supportive of the rotor, the clutch bearing including:
one or more rolling elements supportive of the rotor; and
a plurality of bearing races configured to retain the one or more rolling elements, the bearing race including a coating of thin dense chromium to reduce corrosion and/or damage of the clutch bearing.

10. The transportation refrigeration unit of claim 9, wherein the coating is at least 0.000040″ thick.

11. The transportation refrigeration unit of claim 9, wherein the rolling element bearing is one of a roller bearing, angular contact bearing, taper bearing, spherical bearing, cylindrical bearing or needle bearing.

12. The transportation refrigeration unit of claim 9, wherein the rolling elements are formed from a ceramic material.

13. The transportation refrigeration unit of claim 9, wherein the rotor is belt-driven.
